(19) United States
(12) Patent Application Publication
(10) Pub. No.: US 2009/0109988 A1
(43) Pub. Date: Apr. 30, 2009

(54) Video Decoder with an Adjustable Video Clock

(76) Inventors: Chowdhary Musunuri, San Jose, CA (US); David J. Mackie, San Jose, CA (US); Richard T. Wales, Sunnyvale, CA (US); J. William Mauchly, Berwyn, PA (US)

Correspondence Address: DOV ROSENFELD, 5507 COLLEGE AVE, SUITE 2, OAKLAND, CA, 94618, US

(21) Appl. No.: 11/925,013

(22) Filed: Oct. 26, 2007

(51) Int. Cl. H04L 12/56

(52) U.S. Cl. 370/412

(57) ABSTRACT

A method, an apparatus, and logic encoded in a computer-readable medium to carry out a method. The method includes receiving packets containing compressed video information, storing the received packets in a buffer memory, timestamping the received packets according to an adjustable clock; and removing packets from the buffer for decoding and playout of the video information, the removing according to playback order and at a time determined by the adjustable clock. The method includes adjusting the adjustable clock from time to time according to a measure the amount of time that the packets reside in the buffer memory, such that time latency caused by the buffer memory is limited. An overrun or an underrun of the buffer memory is unlikely.

### FIELD OF THE INVENTION

The present disclosure relates generally to video decoding.

### BACKGROUND

Real time video decoding is applied in such applications as video-conferencing, including what is currently called telepresence and immersive video conferencing in which video information is presented at relatively high definition and large size to provide a an experience for a participant as if the other, remote participant is close by.

With high definition display, defined herein as at least 700 lines of video information presented at a rate of at least 25 pictures per second, e.g., 720p which presents 720 line at 60 pictures per second, 1080i, which presents 1080 lines at 30 pictures per second, each picture comprised of two interlaced fields, and 1080p which presents 1080 lines at 60 pictures per second. Processing such data in a real-time interactive environment requires relatively low latency. Conventional video decoders are not designed with low-latency as an important feature.

In a video processing system such as a videoconferencing terminal that is coupled to a network that may impose an unknown network delay, buffering is used for the incoming compressed data—also called coded data—to allow constant bitrate processing of data that might include vide information that arrives at different rates. For example, video data might include intra-coded pictures (called I-frames), predicatively coded pictures called P-frames, and bidirectionally predicted pictures, called B-frames. A coded picture thus may use a different amount of data. A decoder decodes such data. The display of decoded data is typically at a constant frame rate, so that in a typical processing system, there is at least one input buffer and at least one output buffer. All buffering causes delay. There thus is a desire to reduce the amount of buffering.

Suppose a buffer is very small in order to reduce latency, e.g., between one and two frame's worth of data. Recall that normally the display of decoded data occurs at a constant frame rate according to a clock, e.g., a decoding clock. Another clock is used by a remote encoder to encode the video. With such a small buffer at the receiving terminal, there may not be sufficient data in the buffer to display a next frame, or there may be too much data in the buffer so that the buffer will be full and unable to accept more data. Suppose, for example, that the video data is encoded in real time by a remote encoder that includes a remote encoding clock, and suppose that the data is decoded using a decoding clock. There may be clock skew between the remote encoder's clock and the decoding clock. In such a case, underflow or overflow of the buffer can occur, e.g., if the buffer is too small.

In prior art systems, such underflow or overflow might lead to frame add or frame drop operations. For example, a frame drop implies a whole frame time of latency has built up. At 30 frames per second, this is about 33 ms of latency. In many applications such an additional latency may not be well tolerated. It is desired to use a relatively small buffer to maintain low latency, and also to maintain the buffer “not too full” and “not too empty.” Furthermore, it is designed to have a decoding system that uses a clock that can synchronize with a remote encoding clock used in a remote encoder.

### SUMMARY

Embodiments of the present invention include a method, an apparatus, and logic encoded in one or more computer-readable tangible medium to carry out a method.

Particular embodiments include a method comprising receiving packets containing compressed video information for a time sequence of pictures, e.g., compressed by a remote encoder operating according to a remote encoding clock. The method further includes storing the received packets in a buffer memory, for example storing the received packets in order of arrival. The method further includes timestamping the received packets according to an adjustable clock to provide a timestamp of the received packets, and removing packets from the buffer for playout of the video information in the packets, the removing according to playback order and at a time determined by the adjustable clock. In one version, the removing is according to playback order, and the method includes decoding the packets removed such that the decoding is according to the adjustable clock. The method further includes adjusting the adjustable clock from time to time according to a measure of the amount of time that the packets reside in the buffer memory, such that time latency caused by the buffer memory is limited. Overrun and underrun of the buffer memory are then unlikely. In the example in which the compressed video information is compressed by the remote encoder operating according to the remote encoding clock, the adjustable clock becomes synchronized to the remote encoding clock.

One embodiment includes an apparatus comprising a network interface coupled to a network and operative to receive packets from the network, the received packets containing compressed video information for a time sequence of video frames. The apparatus includes a buffer memory coupled to the network interface and configured to store the received packets, the buffer memory having or coupled to output logic. The apparatus further includes an adjustable clock, a timestamper coupled to the adjustable clock and operative to timestamp the received packets according to the adjustable clock to provide a timestamp of the received packets and a decoder coupled to the output logic of the buffer memory and to the adjustable clock, the decoder operative to output and decompress the video information from packets in the buffer memory that correspond to a picture and to generate a displayable output of the decompressed picture. The removing of compressed video information from the buffer and generation of displayable output is according to the rate of the adjustable clock. The apparatus includes a clock adjustment controller coupled to the adjustable clock and configured to adjust the rate of the adjustable clock according to a measure of the amount of time that the packets corresponding to a frame of video data reside in the buffer memory, such that time latency caused by the buffer memory is limited. Overrun and underrun of the buffer memory are then unlikely.

Particular embodiments include a computer-readable medium encoded with computer-executable instructions that when executed by one or more processors cause an apparatus that includes the one or more processors to carry out a method comprising receiving packets containing compressed video information for a time sequence of pictures, e.g., compressed by a remote encoder operating according to a remote encoding clock. The method further includes storing the received packets in a buffer memory, for example storing the received packets in order of arrival. The method further includes timestamping the received packets according to an adjustable clock to provide a timestamp of the received packets, and removing packets from the buffer for playout of the video information in the packets, the removing at a time determined by the adjustable clock. In one version, the removing is according to playback order, and the method includes decoding the packets removed such that the decoding is according to the adjustable clock. The method further includes adjusting the adjustable clock from time to time according to a measure of the amount of time that the packets reside in the buffer memory, such that time latency caused by the buffer memory is limited. Overrun and underrun of the buffer memory are then unlikely. In the example in which the compressed video information is compressed by the remote encoder operating according to the remote encoding clock, the adjustable clock becomes synchronized to the remote encoding clock.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### BRIEF DESCRIPTION OF THE DRAWINGS

FIG. 1 shows a simplified block diagram of one apparatus that implements the method.

FIG. 2 shows one embodiment of a method that implements a method, e.g., a method that operates on the apparatus shown in FIG. 1.

FIG. 3 shows a simplified block diagram of a videoconferencing terminal that includes an embodiment of the present invention.

FIG. 4 shows a more detailed block diagram of a video processing part of a videoconferencing terminal that includes an embodiment of the present invention.

FIGS. 5A, 5B, and 5C show features of a simulation a video call with a receiving apparatus according to an embodiment of the present invention.

### DESCRIPTION OF EXAMPLE EMBODIMENTS

Embodiments of the present invention include a method, an apparatus, and logic encoded in one or more computer-readable tangible mediums to carry out a method. The method includes adjusting the display time of decoded video data arriving via a network according to a measure of the amount of time data has been in an input buffer.

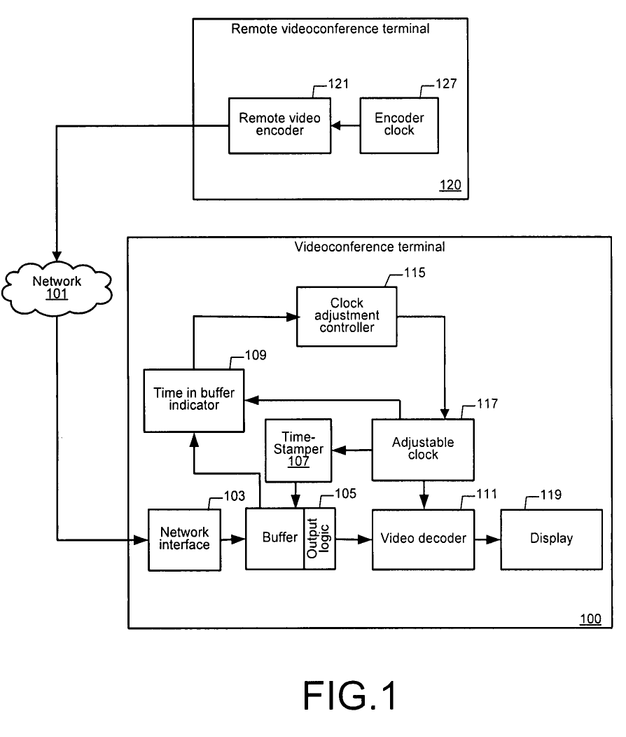

FIG. 1 shows a simplified block diagram of one apparatus that implements the method. Packets containing compressed video data—e.g., IP packets containing high definition video data compressed according to an implementation of an H.264/AVC encoder—are sent from a remote location and received via a network 101 at a network interface 103. In one embodiment, the video data includes video data of 1080 lines at a frame rate of 30 frames per second. In one embodiment, the video data for a frame of video data is contained in a fixed number of packets, e.g., 45 packets. In alternate embodiment, fewer or more of a frame's compressed video data is in a packet. In one embodiment, the video data is encoded in the packets using RTP.

In one embodiment, the network interface 103 is part of or coupled to a video conferencing terminal 100 operative to send and receive video data over the network 101 in real time as part of a videoconferencing system that includes a remote videoconferencing terminal 120. The packets received are from a remote encoder 121 that is part of the remote videoconferencing terminal 120. In order not to obscure the inventive parts, only some of each terminal's elements are shown in FIG. 1. Not shown in terminal 100, for example, are elements related to sending information over the network, to switching between several video sources, or to audio processing. Not shown in remote terminal 120, for example, are elements related to receiving information via the network 101 from other videoconferencing terminals such as terminal 100. Furthermore, while one embodiment is described in the context of video conferencing, the invention is not limited to such applications.

In one embodiment the remote terminal 120 includes a remote encoder 121 that encodes according to a remote encoding clock 127 coupled to the remote encoder 121.

The terminal 100 includes or is coupled to the network interface 103 and includes a buffer memory 105 coupled to the interface. Packets containing video information, e.g., encoded by the remote encoder 121 arrive from the network 101 via the network interface 103 and are stored in the input buffer memory 105. A timestamper 107 is operative to timestamp the packets arriving in the input buffer to provide an indication of the time of arrival of packets. The timestamper 107 in one embodiment uses a counter that operates according to an adjustable clock 117. Packets are output from the buffer memory 105 to a decoder 111 via output logic in or coupled to the buffer memory 105. The decoder 111 is operative to decompress the video information in the packets to produce decompressed video information and output the decompressed video information to a display 119. In one embodiment, the video decoder 111 is arranged to decode a frame of data at a fixed amount of time.

Packet are transported via the network 101 using RTP. The packet order is encoded at the network level. The buffer memory 105 allows for the re-ordering of packets as follows. In on embodiment, the storing of the received packets is in order of arrival, and the removing of the packets for playout is in playback (display) order, e.g., via an indexed list. The outputting according to playback order is carried out, for example, by the output logic. Because of this feature, there is no need for what in the H.264 standard's hardware reference decoder (HRD) is called a Coded Picture Buffer (CPB), and one embodiment indeed does not include a physical HRD-compliant Coded Picture Buffer (CPB). The input buffer 105 acts as a playout buffer. Video information from the packets is delivered to the video decoder 111 via a short hardware FIFO in the decoder (the FIFO is not shown), on a just-in-time basis.

Of course while one embodiment uses ordering in the buffer 105, so does not require and indeed does not use a physical HRD-compliant CPB, alternate embodiments do include a buffer that can operate as a compliant CPB, such that the decoder can operate in a manner compliant to the H.264/AVC hardware reference decoder (HRD) specified in the H,264/AVC standard.

The rate of decoding video packets from the input buffer memory is according to the adjustable clock 117. The adjustable clock 117 is coupled to a clock adjustment controller 115 that is operative to adjust the rate according to an indication of the amount of time that the packets corresponding to a frame or parts of a frame of video data resides in the buffer memory 105. The indication of the time information corresponding to a frame of video is in the input buffer is obtained by a time in buffer indicator 109 that is coupled to the input buffer. The adjusting of the video clock is such that time latency caused by the buffer memory is limited. Overrun and underrun of the buffer memory are then unlikely. In one embodiment in which the packets received contain video information encoded by a remote encoder 121 that operates according to a remote encoding clock, the adjusting of the adjustable clock is such that the clocks are synchronized so that underflow or overflow of the buffer does not occur. Note that by use of the term synchronization does not limit the two clocks to operate at exactly the same nomial frequency. The encoder clock for example can operate at a multiple of the adjustable clock's nominal frequency, or vice-versa.

One embodiment of the invention includes a decoder that decodes video information encoded according to the H.264/AVC standard. The decoder 111 takes a relatively little amount of time to decode the data, and thus has a short latency by use of a plurality of decoding processors that operate in parallel. In one embodiment, each decoding processor of the decoder 111 is able to decode the data of a small number of slices of video data. Each slice, for example, includes a row of blocks of video data. In one embodiment, each decoding processor decodes a single slice of video information. A network abstraction layer (NAL) unit is a unit that contains the information of one slice.

In one embodiment, the adjustable clock 117 operates at a nominal frequency of 27 MHz, so that there are 900,000 clock counts per frame. The timings of the packets within the frame are interpolated within this time period.

To account for lost and out-of-order packets, a packets continuity counter is used to determine the position of the packet within the frame. In one embodiment, packet timings within a frame are modelled. In one simplified embodiment, packets are assumed to be equally spaced through the frame interval.

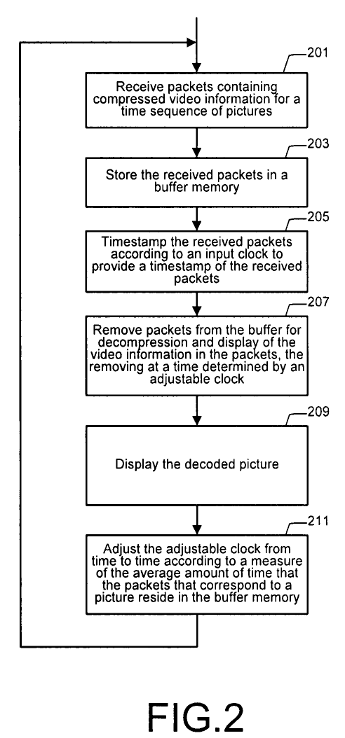

FIG. 2 shows one embodiment of a method that implements a method, e.g., a method that operated on the apparatus shown in FIG. 1. The method includes 201 receiving packets from a network, e.g., from the network 101 via network interface 103. The packets contain compressed video information for a time sequence of pictures, e.g., packets containing information for a sequence of 1080 lines of video compressed according to or substantially according to the H.264/AVC standard. In one embodiment, the packets are transported using RTP. The method includes in 201 storing the received packets in a buffer memory, e.g., buffer memory 105, and in timestamping the received packets, e.g., using a timestamper 107 that operated according to an adjustable clock 117 to provide a timestamp of the received packets. The storing and timestamping in one embodiment are in order of arrival. The method includes in 207 outputting, e.g., removing packets from the buffer 105 for playout of the video information in the packets. In one embodiment, the method includes decompressing the removed packets, e.g., using a video decoder 111 that is arranged to decode a frame of data at a fixed amount of time. The removing of the packets is in playback order, and is at a time determined by the adjustable clock, e.g., adjustable clock 117 that is coupled to the clock adjustment controller 115. The method in 209 includes displaying the decoded picture, e.g., on the display 119. The method includes in 211 adjusting the adjustable clock from time to time according to a measure the amount of time that the packets that correspond to a picture reside in the buffer memory 105 such that time latency caused by the buffer memory is limited. Overrun and underrun of the buffer memory are then unlikely. In one embodiment, the storing of the received packets is in order of arrival from the network, and the removing of the packets for playout is in playback order, such that no physical playout buffering is required.

In one embodiment, the decompressing takes a substantially fixed amount of time.

In one embodiment, the method includes, e.g., in the time in buffer indicator 109, determining the measure of the amount of time packets that correspond to a picture reside in the buffer memory 105. The calculating uses the timestamps of the received packets and in one embodiment determine a measure of the average amount of time that the packets that correspond to a picture reside in the buffer memory.

In one embodiment the clock adjustment controller operates such that the adjusting of the adjustable clock is to maintain the amount of time in the buffer memory 105—such amount of time called the buffer delay herein—at a pre-selected amount of time. One embodiment adjusts the clock such that pre-selected amount of time corresponds to a time delay in the buffer of more than one frame of video data but less than two frames of video data. For an embodiment of 1080 lines of video at 30 complete frames per second, each frame is 33 ms, and the pre-selected amount of time is 50 ms. The invention however is not limited to this amount of time in the buffer.

In one embodiment, the adjustable clock is adjusted from time to time by adding or subtracting a predetermined frequency increment to the clock frequency to speed-up or slow down the adjustable clock 117 so that the measure of the average amount of time is closer to the pre-selected amount of time.

In one embodiment, the adjusting of the clock occurs every pre-selected first number of packets. In one such embodiment, such adjusting that occurs every first number of packets is according to a short term average of the time packets reside in the buffer memory. In one such embodiment, the short term average is obtained every N1 packets. In one embodiment, N1=50 packets. The short term average is the average of the amount of time in the buffer, such average being over the last 50 packets.

In an alternate embodiment, the adjusting of the clock occurs every pre-selected period of time. In one embodiment, the time is 10 seconds.

In general, denote by Ta the time of arrival of a packet, which in one embodiment is also the time the timestamper timestamps that packet according to the adjustable clock. Denote by Td the time that the packet is removed from the input buffer 105 for decoding and display. Denote by Tb the time a packet is in the buffer. Thus

Tb=Td−Ta.

One embodiment ignores packets that arrive after a pre-determined amount of time, that is, that are late packets, for determining the average This applies to packets that arrive after the buffer memory length (in time), so that Tb<0. Such packets may arrive late for many reasons, including network jitter. Such packets are treated as missing packets. Similarly, out of order packets are not considered. Such packets also are treated as missing packets and are not used in the calculations of the average time packets reside in the buffer memory 105. The method knows which packets are dropped or out of order by keeping track of packet numbers in the respective packets headers. In one embodiment, missing packets are replaced by packets that include empty data, and are dealt with in the decoder, e.g., by error recovery procedures that typically are included in the decoder.

Denote by Ns the number of packets over which the short term average is calculated. Then the short term average, denoted Ts determined as

Ts=Σ_{Ns}(Td−Ta)/Ns=Σ_{Ns}

iTb,

where Σ_{Ns} denotes the sum over the last Ns packets.

In one embodiment, Ns=50. In other embodiments, a different amount is used for the averaging.

In one embodiment, in order to avoid division, the measure of average time is the accumulated time over the Ns packets, without the dividing by Ns.

In one embodiment, the adjustment of the adjustable clock every N1 packets is by speeding up or slowing down the clock by a predetermined first frequency increment according to whether the.

In one embodiment, the adjustable clock operates at a frequency of 27 MHz. In one such embodiment, the predetermined first frequency increments by ±10 kHz. Of course, this is not limiting, and other embodiments use an adjustable clock operating at a different frequency. Also other embodiments use a different predetermined first frequency increment.

In addition to maintaining a short term average time, one embodiment further includes maintaining a long term average of the time packets reside in the buffer memory. One such embodiment further includes from time to time adjusting the adjustable clock by a predetermined second frequency according to the long term average.

Denote by N_{L} the number of packets since the start of the video call. Denote further the long term average time for packets to remain in the memory buffer 105 by T_{L}. over which the long term average is calculated. Then the long term average in one embodiment is determined as

T_{L}=Σ_{N}_{_{L}}(Td−Ta)/Ns

where Σ_{N}_{_{L}} denotes the sum over the last N_{L} packets, N_{L} being the number of packets since the start of the call.

In one embodiment in which the adjustable clock operates at a frequency of the predetermined second frequency increment by ±100 Hz. Of course, this is not limiting, and other embodiments use a different predetermined second frequency increment.

In one embodiment, the adjusting of the clock according to the long term average occurs every pre-selected second number of packets. In one such embodiment, such adjusting that occurs every second number of packets is carried out every N2 packets. In one embodiment, N2=100 packets. The short term average is the average of the amount of time in the buffer, such average being over the last 50 packets.

Note that the number of packets typically varies from frame to frame.

If a packet is lost, then it cannot be processed, obviously. One embodiment includes noting the absence of the packet, e.g., using continuity labels on the packets at the time it is scheduled to be delivered to the decoder. At the end of that frame the method includes signalling the encoder that data was lost.

Late packets are not entered into the buffer memory. One method embodiment considers such late packets as missing packets. The amount of lateness is still ascertained, and the count of the number of late packets is maintained. The information can be used to adjust the latency of the system. One embodiment includes providing for playback packets containing empty video information in place of missing or late packets. For example, such late or missing packets are replaced by packets that include empty data, e.g., an empty NAL unit, and are dealt with in the decoder, e.g., by error recovery procedures that typically are included in the decoder.

Yet another embodiment adjusts the clock frequency according to changes in the short term average. Denote the updated clock frequency by f_{CLK|new} and the clock frequency prior to adjustment by f_{CLK|old}, respectively. Furthermore, denote the short term new average by Ts_{|new} and the previous short term average occupancy by Ts_{|old} . Then in one embodiment,

f_{CLK|new}=f_{CLK|old}+Adj_Factor(Ts_{|new}−Ts_{|old}),

where Adj_Factor is a positive adjustment factor, such that if the occupancy time increases, the clock frequency also increases so that packet data is removed from the input buffer memory 105 faster to reduce the average occupancy rate towards a desired target.

In yet another embodiment, the adjusting of the adjustable clock 117 is periodic at a settable period, e.g., every 50 ms.

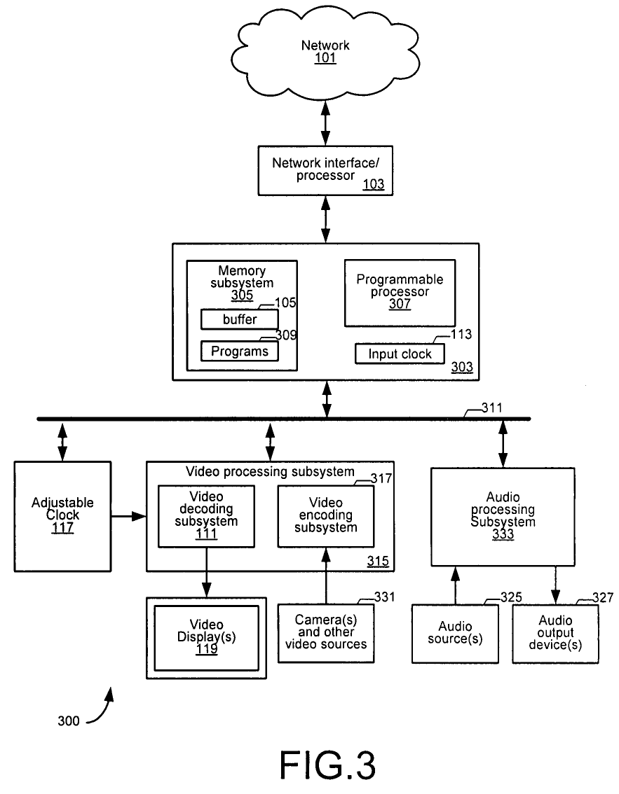

FIG. 3 shows a simplified block diagram, of one “telepresence” type videoconferencing terminal 300 that is one implementation of the terminal 100 of FIG. 1 that includes an embodiment of the present invention and that carries out the method embodiments of the flowchart of FIG. 2. The network interface 103 interfaces the network 101 to a processing system 303 that includes a programmable processor 307 and a memory subsystem 305. The term memory subsystem as used herein includes all forms of tangible storage of digital data, thus might be implemented as one or more RAM, ROM, hard disks, optical media, etc. The memory subsystem 305 implements the buffer memory 105 and also includes computer executable instructions—one or more programs 309—encoded in one or more parts of the memory subsystem 305 that when executed by the processor 307, implement one or more elements of the apparatus of FIG. 1, and the method of FIG. 2. An input clock 113 is included, and used, for example, by the processor executing a program in 309 in implementing the timestamper 107.

The terminal 300 includes a bus subsystem 311 that for simplicity is shown as a single bus 311 and that is used to communicate data and signals between the various elements of the terminal 300. The terminal 300 includes an adjustable clock 117 coupled to the bus subsystem 311. The terminal 300 further includes a video processing subsystem 315 that includes a video encoding system 317 and a video decoding subsystem 111 that implements the video decoder 111 of FIG. 1. One or more video sources 331, e.g., one or more video cameras and possibly other video sources are coupled to the video encoding system that is operative to encode including compress the video information from the video source(s) 331. One or more video displays are included, including the video display 119 of FIG. 1.

In operation, packets containing compressed video arrive from the network 101 via the network interface 103. The processor 307 is operative under control of instructions in 309 to timestamp the incoming packets and to store them in the buffer memory 105 of the memory subsystem 305. At times determined by the adjustable clock 117 in combination with the programmable processor, uncompressed video information is removed from the buffer memory 105 and input to the video decoding subsystem 111 to be displayed by one of the displays. The processing system 303 under control of instructions in 309 is operable to implement the time in buffer indicator 109 and the clock adjustment controller 115 to adjust the frequency of the adjustable clock 117 according to any of the clock adjustment methods described herein.

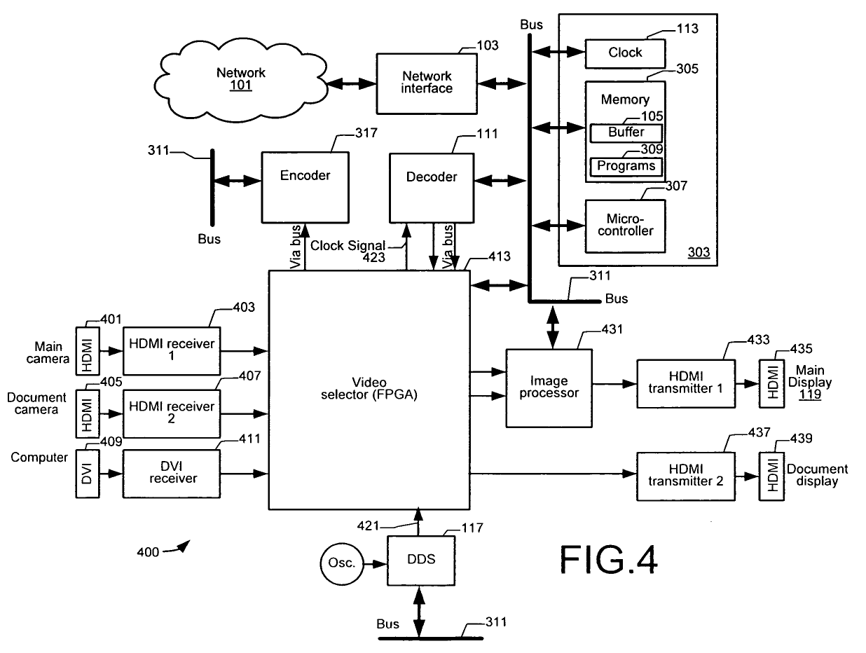

FIG. 4 shows in more detail one particular embodiment 400 of the elements involved for processing video in a terminal that generally follows the architecture of terminal 300 of FIG. 3. One embodiment includes a main camera having an HDMI connector 401, a document camera having an HDMI connector 405 and a computer having a DVI port 409 to provide video inputs via respective receivers: a first HDMI receiver 403 for camera output 401, a second HDMI receiver 407 for document camera output 405, and a DVI receiver 411 for the computer DVI output 409. HDMI (High Definition Multimedia Interface) is a digital video and audio interface specification that was originally designed by a consortium of television manufacturers for dealing with various digital streams, including uncompressed digital HDTV streams. See www.hdmi.org, while DVI (Digital Video Interface) is an older digital video standard. The receivers convert the serial HDMI or DVI streams into respective parallel digital video input signals. In one embodiment, the video stream from the main camera is a 16-bit 4:2:2 YUV high definition format that is selectable to be 1080p, 1080i or 720p or some other format. One embodiment uses 1080 lines at 30 frames per second. The second HDMI receiver 407 that converts the HDMI serial bit stream to parallel video signals that in one embodiment are in 24-bit RGB high definition format that is also is selectable to be 1080p, 1080i or 720p or some other format. Similarly, the DVI input from the computer and DVI receiver 411 produces, in one embodiment, 24-bit RGB video data.

The video inputs are input to a video selector 413 that in one embodiment is a FPGA configured to programmable direct video and clock signals between different elements of the terminal 400. The terminal 400 includes the processing system 303 that includes a microcontroller as the processor 307 and that is coupled to the network 101 via the network interface 103. Note also that in order not to obscure details, various segments of the bus subsystem are shown separately, and furthermore, the bus subsystem 311 is shown as a single bus. Those in the art will understand that modem bus subsystems are more complex.

The video selector s coupled to the bus subsystem 311 and controlled from the microcontroller 307.

The terminal 400 further includes an encoder 317 and a decoder 111. Video to be encoded, e.g., from one or more of the cameras, is transferred via the video selector 413 and via the bus subsystem 311 to the encoder 317. Encoded video is transferred to the network via the bus subsystem 311, the processing system 303, and the network interface 103.

Packets containing video information are received from the network 101 via the network interface 103 and stored in the buffer 103 of the memory subsystem 305, including timestamping according to the clock 113 as described above. The terminal 400 includes a controllable video clock 117 that in one embodiment includes a direct digital synthesizer (DDS) operating at 27 MHz. A DDS synthesizes and generates a waveform directly using digital techniques. The DDS is controlled by programming instructions, in particular, by entering a frequency tuning word loaded to the DDS via the bus subsystem 311 using instructions executing on the processor 307. One embodiment uses a DDS (AD9852 from Analog Devices, Inc., Wilmington, Mass.) that uses a 48-bit control word to finely tune the frequency. The frequency can thus be tuned in increments as small as 0.2 Hz in real-time. The 27 MHz signal is input to the video selector 413 and generates a clock signal 423 for the decoder 111. The decoder derives the video output clock signal at 74.25 MHz from this clock signal. The amount of time video data occupies the buffer 303 is controlled by controlling the DDS in adjustable clock 117 as described above. Video data from the buffer is moved to a buffer (not shown) in the decoder. The decoder includes parallel hardware including a plurality of decoding processors, and in one embodiment, takes a fixed amount of time to decode the data. One embodiment of the decoder 111 is operable to decode high definition (1080 line) video data at 30 frames per second. The decoder 111 is operable to produce two streams of decoded video data.

In addition to the two streams from the decoder, the video selector 413 also accepts an input stream from the local main camera via the first HDMI receiver 403 for output to local displays. The video selector 413 then selects two of the three inputs, e.g., the decoded main camera output and local main camera output from the first HDMI receiver 403, and transfers them to an image processing unit 431 that is operative in conjunction with the video selector 413 to perform functions such as scaling, rate conversions, picture-in-picture (PIP), picture-on-picture (POP), picture-by-picture (PBP) and on-screen-display (OSD). The image processing unit 431 processes the two input streams and combines them with an on-screen display. The output of the image processing unit 431 is forwarded (in one embodiment directly, in another back via the video selector 413) to a first HDMI transmitter 433 and out to a first HDMI connector 435 to a local display 119. The decoder also supplies a second video output via a second HDMI transmitter 437 and connector 439 to a second display which is that of either a decoded document camera or a computer source video from the decoder 111.

The adjustable clock 117 using the DDS in one embodiment operates at 27 MHz that is multiplied to provide signals with 27 MHz or 74.25 MHz video output and 480 line, 720 line or 1080 line resolutions.

In operation, the decoder terminal receives packets from the network 101, and stores them in the relatively small pre-configured buffer memory 105. In one embodiment, the size of the buffer memory 105 is 50 ms. Once the buffer memory 105 is pre-filled, data is drained from this buffer and sent to the decoder 111. The ordering of the data is such that data is removed in display order.

The decoder 111 decompresses the data and renders it on the display 119 using a pixel clock of 74.25 MHz that is derived from the adjustable (DDS) clock 117. Each frame is displayed as it is being decompressed. Hence, high definition frames are decompressed and displayed at 30 frames per second; this is typically the same rate at which raw frames come into a remote encoder from a remote camera at on a remote side of the network 101.

One embodiment monitors an indication of the amount of time data resides the buffer memory 105, e.g., as an average time of occupancy.

Consider two scenarios. In the first scenario, data that is coming into the buffer memory 105 from the network is faster than the rate at which the decoder 111 is decompressing it such that the average time of data occupancy steadily increases over time. This implies that the data is arriving from the network at more than 30 frames per second as seen by the decoder 111. One embodiment of the invention that includes monitoring the average time of occupancy of the buffer memory 105 will cause the adjustable (DDS) clock 117 to speed up and thus cause an increase of the 74.25 Mhz decoder 111 pixel clock to match with the source pixel clock of video arriving from the network 101.

In the second scenario, that data that arrives into the buffer memory 105 from the network is slower than the rate at which the decoder 111 is decompressing data. This implies, for example if the data is remotely generated by a video camera and transmitted via the network, that the camera clock is slower than the decoder 111 playout clock. One embodiment of the invention that includes monitoring the average time of occupancy of the buffer memory 105 will cause the adjustable (DDS) clock 117 to slow down and decrease the 74.25 Mhz decoder 111 pixel clock to match with the remote camera's source pixel clock.

Note that after adjustments of the adjustable (DDS) clock 117, an equilibrium is quickly reached, usually within seconds.

Thus, a relatively small buffer 105 is used, and significantly improves latency that typical video conferencing systems have. In typical video conferencing systems, multiple frames are stored to drop/add for compensating for differences in clock skew. Using an embodiment of the present invention eliminates the clock skew by monitoring the buffer memory 105 average time of occupancy. This gives significantly better user experience compared to products that have higher latency.

### H.264 Fully Compatible HRD Implementation

One of the benefits provided by a standard such as the H.264/AVC standard is the assurance that all the decoders compliant with the standard are able to decode compliant compressed video. For this purpose, the H.264/AVC standard specifies how bits are fed to a fully compliant decoder and how the decoded pictures are removed from such a fully compliant decoder. This includes specifying input and output buffer models for a compliant and developing an implementation independent model of a compliant receiver. That receiver model is also known as the Hypothetical Reference Decoder (HRD). An H.264/AVC compliant HRD specifies operation of two buffers: (i) a Coded Picture Buffer (CPB) and (ii) a Decoded Picture Buffer (DPB). A H.264 CPB models the arrival and removal time of the coded bits.

One feature of some embodiments of the invention is that a CPB is not needed. Instead, a small buffer memory is used. An indication of the time packets spend in the buffer memory is used with a clock adjustment controller to adjust an adjustable clock that sets the video decoding rate such to control the average time packets spend in the buffer memory.

In one alternate embodiment, the apparatus is selectable to be fully H.264/AVC compliant in that it accepts HRD parameters and implements a Coded Picture Buffer (CPB) and a Decoded Picture Buffer (DPB) according to the HRD parameters, Such parameters include an initial buffer delay value, typically small. A H.264/AVC HRD compliant CPB includes examining the buffer at every successive picture output time.

One such alternate embodiment accepts a pre-defined code from the remote encoder to indicate that the encoder requires low-latency, and that normal CPB compliance according to the H.264/AVC HRD standard is not necessary. Unlike a standard HRD, one feature of the present invention is that the buffer memory can be examined more frequently than, say, every second picture boundary, even at sub-picture levels after several rows of macroblocks, to reduce delay in outputting the picture and control an adjustable clock according to which data is decoded and displayed.

### Simulation

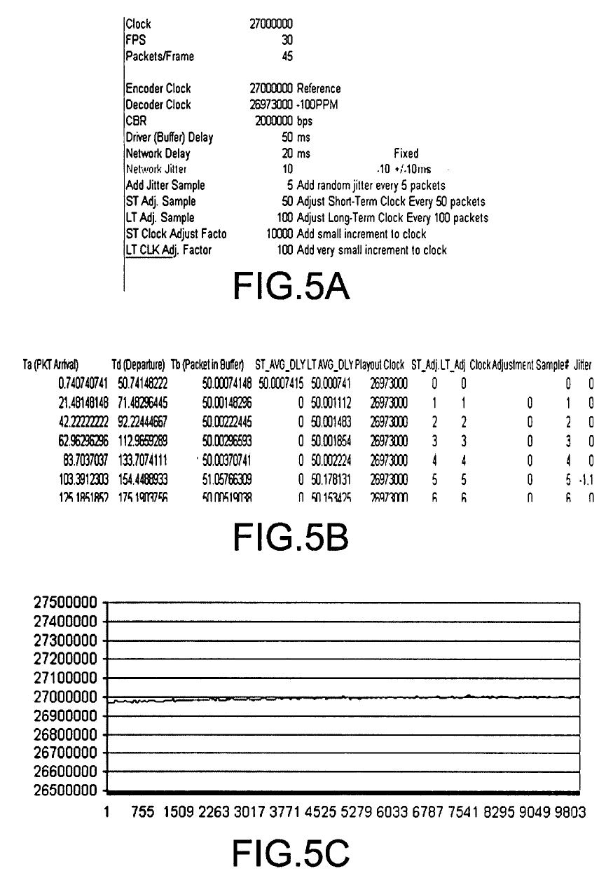

FIGS. 5A, 5B, and 5C show features of a simulation a video call with the receiving apparatus of FIGS. 1 and 3, e.g., in the form of the system shown in FIG. 4, implementing the method shown in the flowchart of FIG. 2 with both long term and short term average adjustment. FIG. 5A summarizes the parameters used. The adjustable clock 117 has a nominal frequency of 27 MHz. A remote encoder uses a similar clock that starts at 27 MHhz. The adjustable clock 117 starts off 100 parts per million too low at 26.973 MHz. The packets are such that there are 45 packets per frame of 1080 lines of video at 30 frames per second (FPS). The bitstream for the simulation has a constant bit rate of 2 Mbps. The buffer memory has a target delay of 50 ms. That is, the clock is adjusted to maintain an average occupancy time of 50 ms in the buffer memory 105. A Network jitter of 10 ms is added to a network delay of 20 ms. The jitter is randomly added every 5 packets. A determining of the short term average of time of occupancy of the buffer memory 105 and an adjustment of the adjustable clock 117 is carried out every 50 packets, the short term average being of the last 50 packets. In addition, a determining of the long term average of time of occupancy of the buffer memory 105 and an adjustment of the adjustable clock 117 is carried out every 100, such long term averaging being of the occupancy since the start of the simulated call. The adjustment every 50 packets according to the short term average is by ±10 kHz, and the adjustment every 100 packets according to the short term average is by ±100 Hz.

FIG. 5B shows some of the starting readings of some of the values of the times and frequencies for the simulation, including: the packet arrival time denoted Ta, the packet departure time denoted Td, and time in the buffer denoted Tb, the short term average denoted ST_AVG_DLY, the long term average delay denoted LT_AVG_DLY, the adjustable clock frequency called denoted Playout Clock in FIG. 5B

FIG. 5C shows a chart of the frequency of the adjustable clock. As can be seen, after about 9000 packets, the adjustable decoder clock “catches” up to the remote simulated encoder clock frequency of exactly 27 MHz.

Thus, an apparatus including a video decoder has been described that achieves low latency by adjusting an adjustable clock receiver clock, for example to match with the clock of a remote encoder sending video in a video conferencing system that includes the remote encoder and the apparatus. The adjusting uses an indication of the amount of time spent in an input buffer.

The method and apparatus described can be used by a video processing system such as a videoconferencing system, e.g., a “telepresence” type videoconferencing system. In typical video conferencing systems, multiple frames are stored in a buffer to drop or add for compensating for differences in clock skew between the clock of a remote encoder and the decoder clock. An embodiment of the present invention eliminates the clock skew by monitoring the buffer time occupancy, e.g., the average occupancy time in the buffer.

Note that the invention is not limited to videoconferencing systems. For example, any video processing system that received video data and that can benefit from low latency can benefit from the invention.

Note that while one embodiment uses a buffer memory that is maintained such that packets remain in the buffer an average of 50 ms, in another embodiment the average time in the buffer is 33 ms, and in yet another embodiment, the average time in the buffer is 67 ms. In one embodiment, the average amount of time in the buffer is software selectable by setting of a parameter. The invention is not limited to any particular length of buffer. One feature of an embodiment is that the buffer can be relatively short to provide relatively small amount of latency.

In one embodiment, a computer-readable medium is encoded with computer-executable instructions that when executed by one or more processors of a terminal, e.g., terminal 100 cause the one or more processors to carry out a method as described herein.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., steps is implied, unless specifically stated.

The methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions.

Furthermore, a computer-readable medium may form, or be included in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagram(s) only show(s) a single processor and a single memory that carries the logic including instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable medium encoded with a set of executable instructions, e.g., a computer program that are for execution on one or more processors, e.g., one or more processors that are part of a teleconferencing terminal. Thus, as will be appreciated by those skilled in the art, embodiments of the present invention may be embodied as a method, an apparatus such as a special purpose apparatus, an apparatus such as a data processing system, or a computer-readable medium, e.g., a computer program product. The computer-readable medium is encoded with logic including a set of instructions that when executed on one or more processors cause the a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the medium is shown in an example embodiment to be a single medium, the term “medium” should be taken to include a single medium or multiple media (e.g., a centralized or distributed database, and/or associated caches and servers) that store the one or more sets of instructions. The term “medium” shall also be taken to include any medium that is capable of storing, encoding or carrying a set of instructions for execution by one or more of the processors and that cause the one or more processors to perform any one or more of the methodologies of the present invention. A medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. For example, the term “medium” shall accordingly be taken to included, but not be limited to, a solid-state memory, a computer product embodied in optical and magnetic media, and a tangible medium bearing a propagated signal detectable by at least one processor of one or more processors and representing a set of instructions that when executed implement a method

It will be understood that the steps of methods discussed are performed in one embodiment by an appropriate processor (or processors) of a processing (i.e., computer) system executing instructions stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It should further be appreciated that although the invention has been described in the context of H.264/AVC, the invention is not limited to such contexts and may be utilized in various other applications and systems, for example in a system that uses MPEG1, MEPG2, VC-1, AVS, or other compressed media streams. Furthermore, the invention is not limited to any one type of network architecture and method of encapsulation, and thus may be utilized in conjunction with one or a combination of other network architectures/protocols.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. A method comprising:
receiving packets containing compressed video information for a time sequence of pictures;
storing the received packets in a buffer memory;
timestamping the received packets according to an adjustable clock to provide a timestamp of the received packets;
removing packets from the buffer for playout of the video information in the packets, the removing at a time determined by the adjustable clock; and
adjusting the adjustable clock from time to time according to a measure of the amount of time that the packets reside in the buffer memory,
such that time latency caused by the buffer memory is limited.

2. A method as recited in claim 1, further comprising decompressing the packets removed from the buffer so that the playout is of decompressed video.

3. A method as recited in claim 1, wherein the storing of the received packets is in order of arrival, and the removing of the packets for playout is in playback order, such that no physical playout buffer is required.

4. A method as recited in claim 1, wherein the compressed video information is compressed by a remote encoder operating according to a remote encoding clock, such that the adjustable clock becomes synchronized to the remote encoding clock.

5. A method as recited in claim 2, wherein the decompressing takes a substantially fixed amount of time.

6. A method as recited in claim 1, further comprising calculating the measure of the amount of time the packets that correspond to a picture reside in the buffer memory, the calculating using the timestamps of the received packets to determine a measure of the average amount of time that the packets that correspond to a picture reside in the buffer memory.

7. A method as recited in claim 6, wherein late packets that arrive after a pre-determined amount of time are not considered in the determining of the measure of the average amount of time.

8. A method as recited in claim 7, wherein the late packets are treated as missing packets, the method further comprising providing for playback packets containing empty video information in place of missing or late packets.

9. A method as recited in claim 6, wherein the adjusting of the adjustable clock is to maintain the average time packets are in the buffer memory at a pre-selected amount of time.

10. A method as recited in claim 9, wherein the pre-selected amount of time corresponds to more than one-half frame of video data but less than two frames of video data.

11. A method as recited in claim 9, wherein the adjusting of the adjustable clock includes adding or subtracting a predetermined frequency increment to speed-up or slow down the adjustable clock so that the measure of the average amount of time is closer to the pre-selected amount of time.

12. A method as recited in claim 9, wherein the adjusting occurs every pre-selected first number of packets.

13. A method as recited in claim 10, wherein the adjusting that occurs every first number of packets is according to a short term average of the time packets reside in the buffer memory, the method further comprising:
adjusting the adjustable clock according to a long term average measure of the amount of time that the packets that correspond to a picture reside in the buffer memory, the adjusting according to a long term average measure occurring every pre-selected second number of packets.

14. A method as recited in claim 1, wherein the video information includes high definition video data.

15. A method as recited in claim 14, wherein the video information is compressed by a method substantially conforming to one of the H.264/AVC coding standard, the AVS standard, or the VC-1 standard.

16. A method as recited in claim 1, wherein the adjusting of the adjustable clock is periodic at a settable period.

17. An apparatus comprising:
a network interface coupled to a network and operative to receive packets from the network, the received packets containing compressed video information for a time sequence of video frames;
a buffer memory coupled to the network interface and configured to store the received packets, the buffer memory having or coupled to output logic;
an adjustable clock;
a timestamper coupled to the adjustable clock and operative to timestamp the received packets according to the adjustable clock to provide a timestamp of the received packets;
a decoder coupled to the output logic of the buffer memory and to the adjustable clock, the decoder operative to output and decompress the video information from packets in the buffer memory that correspond to a picture and to generate a displayable output of the decompressed picture, wherein the removing of compressed video information from the buffer and generation of displayable output is according to the rate of the adjustable clock; and
a clock adjustment controller coupled to the adjustable clock and configured to adjust the rate of the adjustable clock according to a measure of the amount of time that the packets corresponding to a frame of video data resides in the buffer memory,
such that time latency caused by the buffer memory is limited.

18. An apparatus as recited in claim 17, wherein the storing of the received packets is in order of arrival, and the removing of the packets for decoding and playout is in playback order.

19. An apparatus as recited in claim 17, wherein the decoder requires a substantially fixed amount of time to decode the video information in a packet.

20. An apparatus as recited in claim 17, further comprising a time in buffer indicator operative to calculate the measure of the amount of time packets reside in the buffer memory, the calculating using the timestamps of the received packets to determine a measure of the average amount of time that the packets that correspond to a picture reside in the buffer memory.

21. An apparatus as recited in claim 20, wherein clock adjustment controller is configured to adjust the adjustable clock to maintain the average time packets spend in the buffer memory at a pre-selected amount of time.

22. An apparatus as recited in claim 20, wherein the adjusting of the adjustable clock includes adding or subtracting a predetermined frequency increment to speed-up or slow down the adjustable clock so that the measure of the average amount of time is closer to the pre-selected amount of time.

23. An apparatus as recited in claim 21, wherein the adjusting occurs every pre-selected first number of packets.

24. An apparatus as recited in claim 23, wherein the adjusting that occurs every first number of packets is according to a short term average of the time packets reside in the buffer memory, and wherein the clock adjustment controller further is configured to adjust the adjustable clock according to a long term average measure of the amount of time that the packets that correspond to a picture reside in the buffer memory, the adjusting according to a long term average measure occurring every pre-selected second number of packets.

25. A computer-readable medium encoded with computer-executable instructions that when executed by one or more processors cause an apparatus that includes the one or more processors to carry out method comprising:
receiving packets containing compressed video information for a time sequence of pictures;
storing the received packets in a buffer memory in order of arrival;
timestamping the received packets according to an adjustable clock to provide a timestamp of the received packets;
removing packets from the buffer for decoding and playout of the video information in the packets, the removing according to playback order and at a time determined by the adjustable clock;
decoding the packets removed such that the decoding is according to the adjustable clock; and
adjusting the adjustable clock from time to time according to a measure the amount of time that the packets reside in the buffer memory,
such that time latency caused by the buffer memory is limited.
